(19) United States
(12) Patent Application Publication
(10) Pub. No.: US 2026/0011943 A1
(43) Pub. Date: Jan. 8, 2026

(54) CONNECTOR AND CONNECTOR SET

(71) Applicant: Murata Manufacturing Co., Ltd., Kyoto-fu (JP)

(72) Inventor: Yuuto MORITA, Nagaokakyo-shi (JP)

(73) Assignee: Murata Manufacturing Co., Ltd., Kyoto-fu (JP)

(21) Appl. No.: 19/325,827

(22) Filed: Sep. 11, 2025

Related U.S. Application Data
(63) Continuation of application No. PCT/JP2024/002424, filed on Jan. 26, 2024.

(30) Foreign Application Priority Data
Mar. 20, 2023 (JP) 2023-043979

(51) Int. Cl. H01R 12/71; H01R 13/24

(52) U.S. Cl. CPC H01R 12/716; H01R 13/2464

(57) ABSTRACT

A connector includes a first resin body member and one or more first external connection terminals. The one or more first external connection terminals each include a mount portion, a movable portion, a contact portion, and a support portion. The mount portion is electrically connected to an outer electrode of a member when the connector is mounted on the member. The movable portion is connected to the mount portion. The contact portion is connected to the movable portion. The contact portion comes into contact with a second external connection terminal of a second connector when the second connector is connected to the connector. When the movable portion is elastically deformed due to contact between the second external connection terminal and the first external connection terminal, the support portion is supported by the first resin body member and is displaced relative to the first resin body member.

### CROSS-REFERENCE TO RELATED APPLICATION

This application claims benefit of priority to Japanese Patent Application No. 2023-04397, filed Mar. 20, 2023, the entire content of which is incorporated herein by reference.

### BACKGROUND

### Technical Field

The present disclosure relates to a connector and a connector set.

### Background Art

Examples of known connectors in the related art include an electrical connector set disclosed in International Publication No. 2021/070761. The electrical connector set disclosed in International Publication No. 2021/070761 includes a first connector and a second connector connected to each other. The first connector includes a plurality of first external connection terminals. The second connector includes a plurality of second external connection terminals. Each of the second external connection terminals is provided with a third mount portion and a fourth mount portion. The third mount portion is mounted on a second conductor of a second substrate by soldering or the like. The fourth mount portion is mounted on the second conductor of the second substrate by soldering or the like. When the first connector is connected to the second connector, the second external connection terminals come into contact with the first external connection terminals of the first connector.

### SUMMARY

Each of the third mount portion and the fourth mount portion is fixed to the second substrate. Accordingly, when the second external connection terminals come into contact with the first external connection terminals, stress may be concentratedly applied to part of the second external connection terminals and may damage the second external connection terminals. There are thus demands for a reduction of concentrated stress application to part of an external connection terminal.

In view of this, the present disclosure provides a connector that can reduce concentrated stress application to part of an external connection terminal.

According to an aspect of the present disclosure, a connector includes a first resin body member, and one or more first external connection terminals. The one or more first external connection terminals each include a mount portion, a movable portion, a contact portion, and a support portion. The mount portion is electrically connected to an outer electrode of a member when the connector is mounted on the member. The movable portion is connected to the mount portion. The contact portion is connected to the movable portion. The contact portion comes into contact with a second external connection terminal of a second connector when the second connector is connected to the connector. Also, when the movable portion is elastically deformed due to contact between the second external connection terminal and the first external connection terminal, the support portion is supported by the first resin body member and is displaced relative to the first resin body member.

The connector according to the present disclosure can reduce concentrated stress application to part of an external connection terminal.

### BRIEF DESCRIPTION OF THE DRAWINGS

FIG. 1 is a perspective view of a connector set according to a first embodiment;

FIG. 2 is a perspective view of a first connector not connected to a second connector in the first embodiment;

FIG. 3 is a perspective view of first signal terminals, second signal terminals, and first ground terminals in the first connector according to the first embodiment;

FIG. 4 is a perspective view of the first signal terminal according to the first embodiment;

FIG. 5 is a forward sectional view of the first signal terminal according to the first embodiment;

FIG. 6 is a sectional view taken along A-A of the first connector not connected to the second connector in the first embodiment;

FIG. 7 is a perspective view of the second connector according to the first embodiment;

FIG. 8 is a perspective view of third signal terminals and second ground terminals in the second connector according to the first embodiment;

FIG. 9 is a sectional view taken along A-A of the second connector not connected to the first connector in the first embodiment;

FIG. 10 is a perspective view of the first connector connected to the second connector in the first embodiment;

FIG. 11 is a sectional view taken along A-A of the connector set according to the first embodiment;

FIG. 12 is a forward sectional view of the first signal terminal and its vicinity when a first connector according to a first modification and the second connector are not connected to each other;

FIG. 13 is a leftward sectional view of the first signal terminal and its vicinity when the first connector according to the first modification and the second connector are not connected to each other;

FIG. 14 is a forward sectional view of the first signal terminal and its vicinity when a first connector according to a second modification and the second connector are not connected to each other; and

FIG. 15 is a forward sectional view of the first signal terminal and its vicinity when a first connector according to a third modification and the second connector are not connected to each other.

### DETAILED DESCRIPTION

### First Embodiment

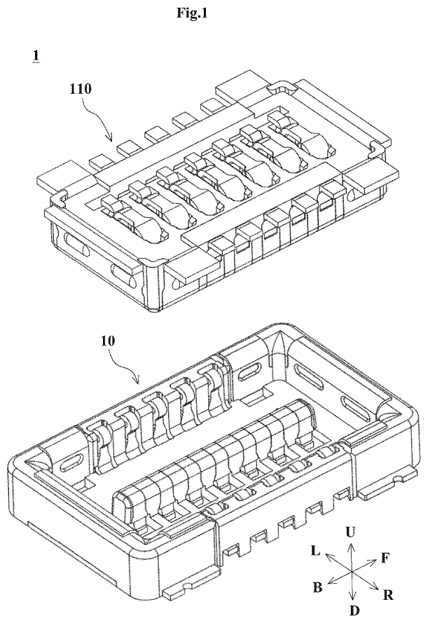

With reference to the drawings, description is made hereinafter of a connector set 1 including a first connector 10 according to the first embodiment of the present disclosure. FIG. 1 is a perspective view of the connector set 1 according to the first embodiment.

The present specification defines directions as follows. A direction from a second connector 110 to the first connector 10 is defined as a downward direction. A direction opposing the downward direction is defined as an upward direction. In the first connector 10, a direction in which first ground terminals 14b and 14f are aligned in the mentioned order is defined as a forward direction. A direction opposing the forward direction is defined as a backward direction. The forward direction or the backward direction is perpendicular to the downward direction or the upward direction. A direction perpendicular to the downward direction and the forward direction is defined as a rightward direction. A direction opposing the rightward direction is defined as a leftward direction. The downward direction, the upward direction, the forward direction, the backward direction, the rightward direction, and the leftward direction according to the present specification are defined for convenience of description, and do not need to match a downward direction, an upward direction, a forward direction, a backward direction, a rightward direction, and a leftward direction of the connector set 1 in use. In each of the drawings, the downward direction and the upward direction may be replaced with each other, the forward direction and the backward direction may be replaced with each other, and the rightward direction and the leftward direction may be replaced with each other.

The present specification defines positional relations of members as follows. A first member to a third member constitute the connector set 1. In the present specification, the first member disposed on or above the second member forms the following state. At least part of the first member is positioned just above the second member. The first member is thus overlapped with the second member in downward view. This definition applies also to directions other than the upward direction.

In the present specification, a state where the first member is disposed higher in level than the second member includes a case where at least part of the first member is positioned just above the second member and a case where the first member is positioned not just above but diagonally above the second member. In these cases, the first member does not need to be overlapped with the second member in downward view. Examples of diagonally above include upper left and upper right. This definition applies also to directions other than the upward direction.

Unless otherwise specified, the present specification defines each part of the first member as follows. A front portion of the first member means a front half of the first member. A front end of the first member means an end in the forward direction of the first member. A front end portion of the first member means the front end and its vicinity of the first member. These definitions apply also to directions other than the forward direction.

When any two appropriate members in the present specification are defined as the first member and the second member, these two appropriate members are assumed to have the following relation. In the present specification, a state where the first member is supported by the second member includes a case where the first member is immovably attached (i.e., fixed) to the second member and a case where the first member is movably attached to the second member. Furthermore, the state where the first member is supported by the second member includes both a case where the first member is directly attached to the second member and a case where the first member is attached to the second member with the third member interposed therebetween.

In the present specification, a state where the first member is retained by the second member includes a case where the first member is immovably attached (i.e., fixed) to the second member, and does not include a case where the first member is movably attached to the second member. Furthermore, the state where the first member is retained by the second member includes both the case where the first member is directly attached to the second member and the case where the first member is attached to the second member with the third member interposed therebetween.

In the present specification, “the first member and the second member are electrically connected to each other” means that electricity is conducted between the first member and the second member. Accordingly, the first member and the second member may be in contact with each other or may be in non-contact with each other. When the first member is in non-contact with the second member, the third member having conductivity is located between the first member and the second member.

In the present specification, a member extending in an upward-downward direction means a member inclined from the upward-downward direction within a range of ±45 degrees. Similarly, a member extending in a forward-backward direction does not necessarily mean only a member parallel to the forward-backward direction. The member extending in the forward-backward direction means a member inclined from the forward-backward direction within a range of ±45 degrees. A member extending in a rightward-leftward direction means a member inclined from the rightward-leftward direction within a range of ±45 degrees.

The connector set 1 is used to connect two circuit boards or the like. As shown in FIG. 1, the connector set 1 includes the first connector 10 and the second connector 110. When the first connector 10 and the second connector 110 are connected to each other, the second connector 110 is positioned on or above the first connector 10.

### Structure of First Connector

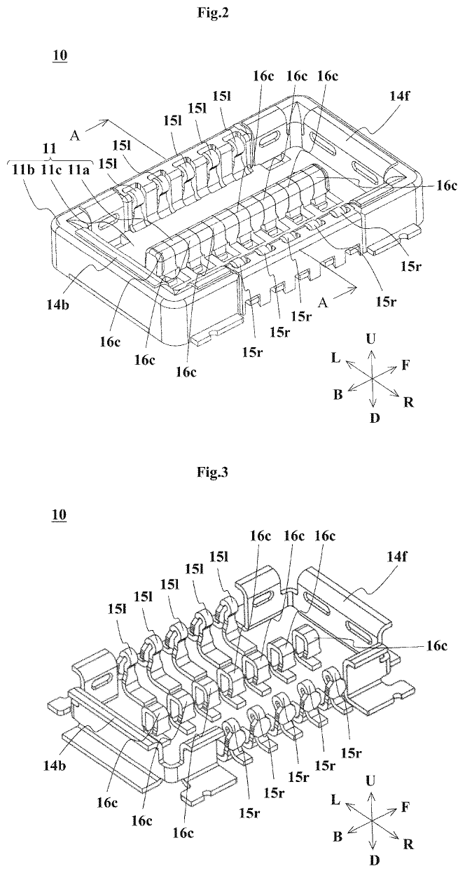

Described next with reference to the drawings is a structure of the first connector 10. FIG. 2 is a perspective view of the first connector 10 not connected to the second connector 110 in the first embodiment. FIG. 3 is a perspective view of first signal terminals 151 and 15r, second signal terminals 16c, and the first ground terminals 14b and 14f in the first connector 10 according to the first embodiment.

As shown in FIGS. 2 and 3, the first connector 10 includes a first resin body member 11, the first ground terminals 14b and 14f, the plurality of first signal terminals 151 and 15r, and the plurality of second signal terminals 16c. The first resin body member 11, the first ground terminals 14b and 14f, the plurality of first signal terminals 151 and 15r, and the plurality of second signal terminals 16c are integrally formed by press fit molding. Each of the first signal terminals 151 and 15r corresponds to a “first external connection terminal”.

As shown in FIG. 2, the first resin body member 11 includes a protrusion 11a, a frame 11b, and a coupler 11c. The protrusion 11a extends in the forward-backward direction in downward view. More specifically, the protrusion 11a in downward view has two long sides extending in the forward-backward direction and two short sides extending in the rightward-leftward direction.

The frame 11b has a ring shape surrounding the protrusion 11a in downward view. The frame 11b has a left side and a right side extending in the forward-backward direction, and a front side and a rear side extending in the rightward-leftward direction. The protrusion 11a is positioned in a region surrounded by the frame 11b in downward view. The frame 11b is not in contact with the protrusion 11a.

The coupler 11c is positioned between the protrusion 11a and the frame 11b in downward view and couples the protrusion 11a and the frame 11b. The coupler 11c couples a lower portion of the protrusion 11a and a lower portion of the frame 11b. The first resin body member 11 is made of an insulating material. Examples of the material for the first resin body member 11 include a resin.

The first ground terminals 14b and 14f are connected to ground potential. The first ground terminals 14b and 14f are supported by the first resin body member 11. More specifically, each of the first ground terminal 14b and the first ground terminal 14f is partially embedded in the left side of the frame 11b. Each of the first ground terminal 14b and the first ground terminal 14f is partially embedded in the right side of the frame 11b. The first ground terminal 14b is partially embedded in the rear side of the frame 11b. The first ground terminal 14f is partially embedded in the front side of the frame 11b. The first ground terminals 14b and 14f are thus aligned in the mentioned order from backward to forward. The first ground terminals 14b and 14f are each manufactured by bending a metal member having a plate shape. The first ground terminals 14b and 14f may be made of a copper material such as phosphor bronze.

The plurality of first signal terminals 151 and 15r and the plurality of second signal terminals 16c each receive and output radio-frequency signals. Each of the first signal terminals 151 is embedded in the left side of the frame 11b. The first signal terminals 151 are thus supported by the frame 11b so as to be aligned in the forward-backward direction in a leftward region of the protrusion 11a. The frame 11b is located between the plurality of first signal terminals 151. The first signal terminals 151 are each manufactured by bending a metal member having a plate shape. The first signal terminals 151 may be made of a copper material such as phosphor bronze.

Each of the first signal terminals 15r is embedded in the right side of the frame 11b. The plurality of first signal terminals 15r is thus supported by the frame 11b so as to be aligned in the forward-backward direction in a rightward region of the protrusion 11a. The frame 11b is located between the plurality of first signal terminals 15r. The first signal terminals 15r are each manufactured by bending a metal member having a plate shape. The first signal terminals 15r may be made of a copper material such as phosphor bronze.

Each of the second signal terminals 16c is embedded in the protrusion 11a. The plurality of second signal terminals 16c is thus supported by the protrusion 11a so as to be aligned in the forward-backward direction in a region overlapped with the protrusion 11a in downward view. The protrusion 11a is located between the plurality of second signal terminals 16c. The second signal terminals 16c are each manufactured by bending a metal member having a plate shape. The second signal terminals 16c may be made of a copper material such as phosphor bronze.

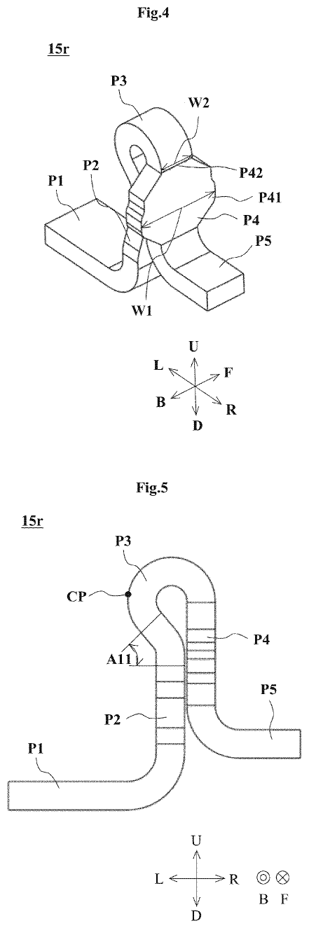

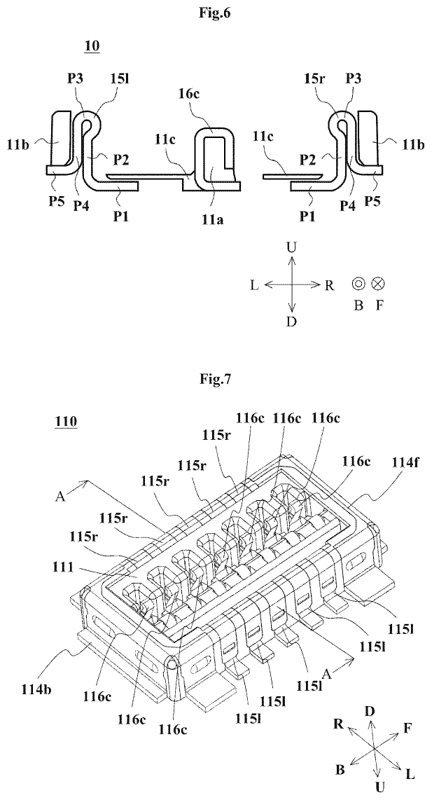

Described in detail with reference to the drawings are structures of the first signal terminals 151 and 15r by exemplifying the first signal terminals 15r. The first signal terminals 151 and the first signal terminals 15r are shaped bilaterally symmetrically in the present embodiment. Accordingly, the structure of the first signal terminals 151 will not be described herein. FIG. 4 is a perspective view of the first signal terminal 15r according to the first embodiment. FIG. 5 is a forward sectional view of the first signal terminal 15r according to the first embodiment. FIG. 6 is a sectional view taken along A-A of the first connector 10 not connected to the second connector 110 in the first embodiment.

As shown in FIGS. 4 and 5, the first signal terminal 15r includes a mount portion P1, a movable portion P2, a contact portion P3, a support portion P4, and a projection P5.

The mount portion P1 extends in the rightward-leftward direction in the present embodiment. More specifically, the mount portion P1 has an upper surface and a lower surface aligned in the upward-downward direction. The lower surface of the mount portion P1 is electrically connected to an outer electrode (not shown) on a first circuit board when the first connector 10 is mounted on the first circuit board. The lower surface of the mount portion P1 is fixed onto an electrode on the first circuit board by soldering (not shown) or the like. The first circuit board corresponds to a “member”.

The movable portion P2 extends in the upward-downward direction in the present embodiment. More specifically, the movable portion P2 has a left surface and a right surface aligned in the rightward-leftward direction. The movable portion P2 is positioned higher in level than the mount portion P1. The movable portion P2 is connected to the mount portion P1. In other words, the movable portion P2 is provided continuously to the mount portion P1. More specifically, the movable portion P2 has a lower end connected to a right end of the mount portion P1.

The contact portion P3 has a curved shape to project upward in the present embodiment. More specifically, the contact portion P3 has an outer peripheral surface directed upward and an inner peripheral surface directed downward. The contact portion P3 is positioned higher in level than the movable portion P2.

The contact portion P3 includes a curved zone A11 shaped to be curved in the present embodiment. More specifically, the curved zone A11 is curved in the rightward-leftward direction. The contact portion P3 is connected to the movable portion P2. In other words, the contact portion P3 is provided continuously to the movable portion P2. More specifically, the contact portion P3 has a lower left end connected to an upper end of the movable portion P2. The contact portion P3 is connected to the movable portion P2 in the curved zone A11. In other words, the contact portion P3 is provided continuously to the movable portion P2 in the curved zone A11.

When the second connector 110 is connected to the first connector 10, a third signal terminal 115r to be described later and included in the second connector 110 comes into contact with the contact portion P3. More specifically, the third signal terminal 115r of the second connector 110 comes into contact with a contact position CP of the contact portion P3 as shown in FIG. 5 when the second connector 110 is connected to the first connector 10.

The support portion P4 extends in the upward-downward direction in the present embodiment. More specifically, the support portion P4 has a left surface and a right surface aligned in the rightward-leftward direction. The support portion P4 and the movable portion P2 are in contact with each other when the second connector 110 is not connected to the first connector 10 in the present embodiment. More specifically, the left surface of the support portion P4 and the right surface of the movable portion P2 are in contact with each other when the second connector 110 is not connected to the first connector 10. The support portion P4 is positioned lower in level than the contact portion P3. The support portion P4 has a lower end positioned higher in level than the mount portion P1. The support portion P4 is positioned on the right side of the movable portion P2. The support portion P4 is connected to the contact portion P3. In other words, the support portion P4 is provided continuously to the contact portion P3. More specifically, the support portion P4 has an upper end connected to a lower right end of the contact portion P3.

As shown in FIG. 4, the support portion P4 includes a support portion maximum width portion P41 marking a support portion width maximum value W1 and a support portion minimum width portion P42 marking a support portion width minimum value W2. Herein, the support portion width maximum value W1 is defined as a maximum value of a width in a direction perpendicular to the upward-downward direction of the support portion P4. Furthermore, the support portion width minimum value W2 is defined as a minimum value of the width in the direction perpendicular to the upward-downward direction of the support portion P4. The support portion width maximum value W1 is larger than the support portion width minimum value W2. The direction perpendicular to the upward-downward direction corresponds to the forward-backward direction in the present embodiment. That is, the width of the support portion P4 is non-uniform in the direction perpendicular to the upward-downward direction in the present embodiment.

The projection P5 extends in the rightward-leftward direction in the present embodiment. More specifically, the projection P5 extends rightward from the lower end of the support portion P4. The projection P5 has an upper surface and a lower surface aligned in the upward-downward direction. The projection P5 is connected to the support portion P4. In other words, the projection P5 is provided continuously to the support portion P4. More specifically, the projection P5 has a left end connected to the lower end of the support portion P4.

As shown in FIG. 6, at least part of the coupler 11c is positioned just above the mount portion P1 in the present embodiment. The coupler 11c is, however, not in contact with the mount portion P1. The first resin body member 11 is positioned neither just above nor just below the movable portion P2. The first resin body member 11 is positioned neither just above nor just below the contact portion P3. The first resin body member 11 is positioned neither just above nor just below the support portion P4. The support portion P4 is, however, supported by the frame 11b. More specifically, the right surface of the support portion P4 is supported by the frame 11b. That is, the support portion P4 is supported by the first resin body member 11. The first resin body member 11 and each of the first signal terminals 15r are, however, integrally formed by press fit molding, so that a clearance is provided between the right surface of the support portion P4 and the frame 11b. Accordingly, the support portion P4 is movable in the upward-downward direction relative to the first resin body member 11 while being supported by the first resin body member 11. At least part of the frame 11b is positioned just above the projection P5. That is, the first resin body member 11 is positioned on or above the projection P5. The upper surface of the projection P5 is in contact with the frame 11b in the present embodiment. The first signal terminal 15r is, however, not supported by the first resin body member 11 in the portions other than the support portion P4 in the present embodiment. The projection P5 is thus movable downward relative to the first resin body member 11.

The first connector 10 configured as described above is mounted on the first circuit board (not shown) such that a lower surface of the first resin body member 11 faces the first circuit board. More specifically, the first ground terminals 14b and 14f, the plurality of first signal terminals 151 and 15r, and the plurality of second signal terminals 16c are each partially exposed from the lower surface of the first resin body member 11. Solder is applied to each of such exposed portions in this state. The first ground terminals 14b and 14f, the plurality of first signal terminals 151 and 15r, and the plurality of second signal terminals 16c are thus electrically connected to the outer electrode (not shown) on the first circuit board.

### Structure of Second Connector

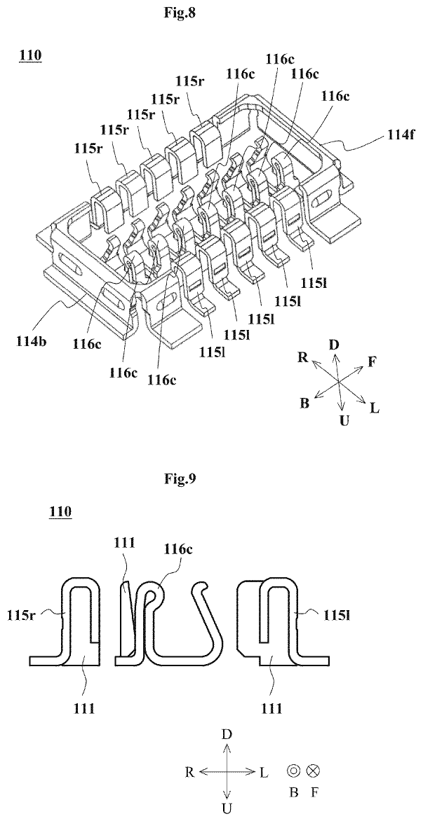

Described next with reference to the drawings is a structure of the second connector 110. FIG. 7 is a perspective view of the second connector 110 according to the first embodiment. FIG. 8 is a perspective view of third signal terminals 1151 and 115r and second ground terminals 114b and 114f in the second connector 110 according to the first embodiment. FIG. 9 is a sectional view taken along A-A of the second connector 110 not connected to the first connector 10 in the first embodiment.

As shown in FIGS. 7 and 8, the second connector 110 includes a second resin body member 111, the second ground terminals 114b and 114f, the plurality of third signal terminals 1151 and 115r, and a plurality of fourth signal terminals 116c. The second resin body member 111, the second ground terminals 114b and 114f, the plurality of third signal terminals 1151 and 115r, and the plurality of fourth signal terminals 116c are integrally formed by press fit molding. Each of the third signal terminals 1151 and 115r corresponds to a “second external connection terminal”

The second resin body member 111 has a ring shape in upward view. More specifically, the second resin body member 111 has an outer edge in a rectangular shape and an inner edge in a rectangular shape in upward view. The outer edge of the second resin body member 111 and the inner edge of the second resin body member 111 each have a left side and a right side extending along a forward-backward axis and a front side and a rear side extending along a rightward-leftward axis in upward view. The second resin body member 111 is made of an insulating material. Examples of the material for the second resin body member 111 include a resin.

The second ground terminals 114b and 114f are connected to ground potential. The second ground terminals 114b and 114f are supported by the second resin body member 111. More specifically, each of the second ground terminal 114b and the second ground terminal 114f is partially embedded in the left side of the second resin body member 111. Each of the second ground terminal 114b and the second ground terminal 114f is partially embedded in the right side of the second resin body member 111. The second ground terminal 114b is partially embedded in the rear side of the second resin body member 111. The second ground terminal 114f is partially embedded in the front side of the second resin body member 111. The second ground terminals 114b and 114f are thus aligned in the mentioned order from backward to forward. The second ground terminals 114b and 114f are each manufactured by bending a metal member having a plate shape. The second ground terminals 114b and 114f may be made of a copper material such as phosphor bronze.

When the second connector 110 is connected to the first connector 10, the second ground terminal 114b comes into contact with the first ground terminal 14b of the first connector 10. The second ground terminal 114b is thus electrically connected to the first ground terminal 14b. When the second connector 110 is connected to the first connector 10, the second ground terminal 114f comes into contact with the first ground terminal 14f of the first connector 10. The second ground terminal 114f is thus electrically connected to the first ground terminal 14f.

The plurality of third signal terminals 1151 and 115r and the plurality of fourth signal terminals 116c each receive and output radio-frequency signals. Each of the third signal terminals 1151 is embedded in the left side of the second resin body member 111. The plurality of third signal terminals 1151 is thus supported by the second resin body member 111 so as to be aligned in the forward-backward direction. The second resin body member 111 is located between the plurality of third signal terminals 1151. The third signal terminals 1151 are each manufactured by bending a metal member having a plate shape. The third signal terminals 1151 may be made of a copper material such as phosphor bronze.

Each of the third signal terminals 115r is embedded in the right side of the second resin body member 111. The plurality of third signal terminals 115r is thus supported by the second resin body member 111 so as to be aligned in the forward-backward direction. The second resin body member 111 is located between the plurality of third signal terminals 115r. The third signal terminals 115r are each manufactured by bending a metal member having a plate shape. The third signal terminals 115r may be made of a copper material such as phosphor bronze.

As shown in FIG. 9, each of the fourth signal terminals 116c is in contact with the second resin body member 111. The plurality of fourth signal terminals 116c is thus supported by the second resin body member 111 so as to be aligned in the forward-backward direction. The fourth signal terminals 116c are each manufactured by bending a metal member having a plate shape. The fourth signal terminals 116c may be made of a copper material such as phosphor bronze.

The second connector 110 configured as described above is mounted on a second circuit board (not shown) such that an upper surface of the second resin body member 111 faces the second circuit board. More specifically, the second ground terminals 114b and 114f, the plurality of third signal terminals 1151 and 115r, and the plurality of fourth signal terminals 116c are each partially exposed from the upper surface of the second resin body member 111. Solder is applied to each of such exposed portions in this state. The second ground terminals 114b and 114f, the plurality of third signal terminals 1151 and 115r, and the plurality of fourth signal terminals 116c are thus electrically connected to an outer electrode (not shown) on the second circuit board.

### Connection Structure Between First Connector and Second Connector

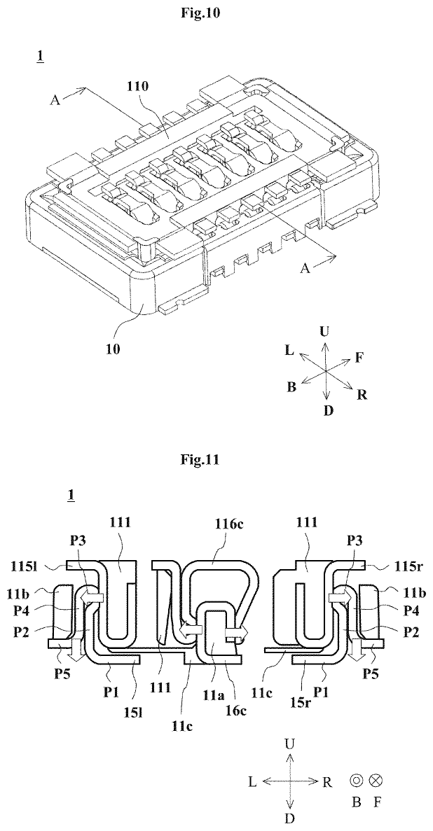

Described next with reference to the drawings is a connection structure between the first connector 10 and the second connector 110. FIG. 10 is a perspective view of the first connector 10 connected to the second connector 110 in the first embodiment. FIG. 11 is a sectional view taken along A-A of the connector set 1 according to the first embodiment.

The second resin body member 111 of the second connector 110 is inserted into the region surrounded by the frame 11b of the first connector 10. In this case, the protrusion 11a of the first connector 10 is inserted into a region surrounded by the second resin body member 111 of the second connector 110. The second ground terminal 114b of the second connector 110 thus comes into contact with the first ground terminal 14b of the first connector 10. Furthermore, the second ground terminal 114f of the second connector 110 comes into contact with the first ground terminal 14f of the first connector 10. The plurality of third signal terminals 1151 of the second connector 110 comes into contact with the plurality of first signal terminals 151 of the first connector 10, respectively. The plurality of third signal terminals 115r of the second connector 110 comes into contact with the plurality of first signal terminals 15r of the first connector 10, respectively. The plurality of fourth signal terminals 116c of the second connector 110 comes into contact with the plurality of second signal terminals 16c of the first connector 10, respectively.

When the plurality of third signal terminals 115r of the second connector 110 comes into contact with the plurality of first signal terminals 15r of the first connector 10, respectively, the movable portions P2 are elastically deformed. The movable portion P2 in each of the first signal terminals 15r of the first connector 10 is elastically deformed in the rightward direction in the present embodiment. In this case, the support portion P4 is displaced relative to the first resin body member 11 while being supported by the first resin body member 11 in the present embodiment. The support portion P4 is displaced in the downward direction relative to the first resin body member 11 while being supported by the first resin body member 11 in the present embodiment. The projection P5 is accordingly displaced in the downward direction relative to the first resin body member 11.

When the plurality of third signal terminals 1151 of the second connector 110 comes into contact with the plurality of first signal terminals 151 of the first connector 10, respectively, the movable portions P2 are elastically deformed. The movable portions P2 in each of the first signal terminals 151 of the first connector 10 are elastically deformed in the leftward direction in the present embodiment. In this case, the support portion P4 is displaced relative to the first resin body member 11 while being supported by the first resin body member 11. The support portion P4 is displaced in the downward direction relative to the first resin body member 11 while being supported by the first resin body member 11 in the present embodiment.

### Effects

The first connector 10 can reduce concentrated stress application to part of an external connection terminal. Description is made by exemplifying the first signal terminals 15r. When the second connector 110 is connected to the first connector 10, each of the third signal terminals 115r comes into contact with the contact portion P3. The movable portion P2 is thus elastically deformed in the rightward direction. The support portion P4 is positioned on the right side of the movable portion P2. The movable portion P2 accordingly presses the support portion P4. The support portion P4 is thus displaced in the downward direction. In this manner, when the movable portion P2 is elastically deformed due to contact between each of the third signal terminals 115r and each of the first signal terminals 15r, the support portion P4 is displaced relative to the first resin body member 11 while being supported by the first resin body member 11. Accordingly, the support portion P4 is displaced relative to the first resin body member 11 to reduce stress applied to the movable portion P2. This achieves a reduction of concentrated stress application to the movable portion P2. The first connector 10 can therefore reduce concentrated stress application to part of an external connection terminal.

The first connector 10 can also reduce plastic deformation of an external connection terminal. More specifically, the support portion P4 and the movable portion P2 are in contact with each other. In the present embodiment, the left surface of the support portion P4 and the right surface of the movable portion P2 are in contact with each other when the second connector 110 is not connected to the first connector 10. The support portion P4 thus supports the movable portion P2 when the movable portion P2 is elastically deformed in the rightward direction. This achieves a reduction of stress applied to the movable portion P2 and a reduction of plastic deformation of the movable portion P2. The first connector 10 can therefore reduce plastic deformation of an external connection terminal.

The first connector 10 can also reduce disengagement of an external connection terminal from the first resin body member 11. More specifically, the projection P5 extends rightward from the lower end of the support portion P4. Furthermore, the first resin body member 11 is positioned on or above the projection P5. The projection P5 is thus caught by the first resin body member 11 when each of the first signal terminals 15r receives upward force. The first connector 10 can therefore reduce disengagement of an external connection terminal from the first resin body member 11.

The first connector 10 can further reduce concentrated stress application to part of an external connection terminal. More specifically, the lower end of the support portion P4 is positioned higher in level than the mount portion P1. This can enlarge a displaceable range of the support portion P4. Accordingly, even when the movable portion P2 is elastically deformed largely in the rightward direction, the support portion P4 is displaced relative to the first resin body member 11 while being supported by the first resin body member 11 so as to reduce stress applied to the movable portion P2. The first connector 10 can therefore reduce concentrated stress application to part of an external connection terminal.

The first connector 10 can also reduce stress applied to the mount portion P1. More specifically, the mount portion P1 is connected to the movable portion P2. Accordingly, when the second connector 110 is connected to the first connector 10, the mount portion P1 also receives stress. The contact portion P3 is connected to the movable portion P2 in the curved zone A11 shaped to be curved. This reduces stress applied to the movable portion P2 when the second connector 110 is connected to the first connector 10. The first connector 10 can therefore reduce stress applied to the mount portion P1.

### First Modification

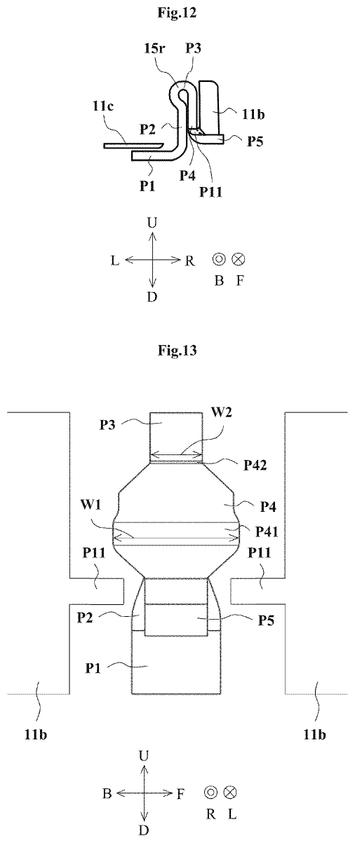

With reference to the drawings, description is made hereinafter of a first connector according to the first modification of the present disclosure. FIG. 12 is a forward sectional view of the first signal terminal 15r and its vicinity when the first connector according to the first modification and the second connector 110 are not connected to each other. FIG. 13 is a leftward sectional view of the first signal terminal 15r and its vicinity when the first connector according to the first modification and the second connector 110 are not connected to each other. In the first connector according to the first modification, description is made only of portions different from portions of the first connector 10 according to the first embodiment, and the remaining portions will not be described repeatedly.

The first connector according to the first modification is different from the first connector 10 according to the first embodiment in that the first resin body member 11 includes an obstructor P11.

The obstructor P11 limits the displaceable range of the support portion P4. More specifically, the obstructor P11 is overlapped with the support portion P4 in downward view. At least part of the obstructor P11 and at least part of the support portion maximum width portion P41 are aligned on a straight line parallel to the upward-downward direction. The obstructor P11 according to the present modification is positioned lower in level than the support portion P4. The obstructor P11 thus limits the displaceable range in the downward direction of the support portion P4.

The first connector according to the first modification as described above also exhibits effects equal to those of the first connector 10. The first connector according to the first modification can also reduce unnecessary displacement of the support portion P4. More specifically, the first resin body member 11 includes the obstructor P11 configured to limit the displaceable range of the support portion P4. The present modification achieves a reduction of unnecessary downward displacement of the support portion P4 because the first resin body member 11 includes the obstructor P11 positioned just below the support portion maximum width portion P41. The first connector according to the first modification can therefore reduce unnecessary displacement of the support portion P4.

### Second Modification

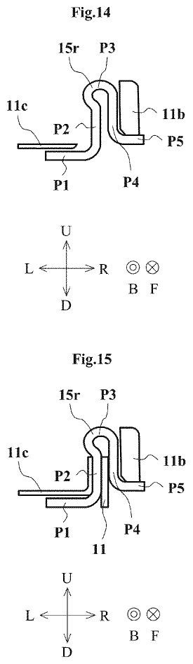

With reference to the drawing, description is made hereinafter of a first connector according to the second modification of the present disclosure. FIG. 14 is a forward sectional view of the first signal terminal 15r and its vicinity when the first connector according to the second modification and the second connector 110 are not connected to each other. In the first connector according to the second modification, description is made only of portions different from portions of the first connector 10 according to the first embodiment, and the remaining portions will not be described repeatedly.

The first connector according to the second modification is different from the first connector 10 according to the first embodiment in that the left surface of the support portion P4 and the right surface of the movable portion P2 are not in contact with each other when the second connector 110 is not connected to the first connector according to the second modification.

The first connector according to the second modification as described above can also reduce concentrated stress application to part of an external connection terminal.

### Third Modification

With reference to the drawing, description is made hereinafter of a first connector according to the third modification of the present disclosure. FIG. 15 is a forward sectional view of the first signal terminal 15r and its vicinity when the first connector according to the third modification and the second connector 110 are not connected to each other. In the first connector according to the third modification, description is made only of portions different from portions of the first connector 10 according to the first embodiment, and the remaining portions will not be described repeatedly.

The first connector according to the third modification is different from the first connector 10 according to the first embodiment in that the movable portion P2 is in contact with the first resin body member 11 and that the support portion P4 is in contact with the first resin body member 11.

More specifically, the left surface of the movable portion P2 is in contact with the coupler 11c. The first resin body member 11 is located between the movable portion P2 and the support portion P4. The right surface of the movable portion P2 is in contact with the first resin body member 11. The left surface of the support portion P4 is in contact with the first resin body member 11. A static friction coefficient between the movable portion P2 and the first resin body member 11 is larger than a static friction coefficient between the support portion P4 and the first resin body member 11.

The first connector according to the third modification as described above also exhibits effects equal to those of the first connector 10. Furthermore, the first connector according to the third modification can reduce stress applied to the mount portion P1. More specifically, the static friction coefficient between the movable portion P2 and the first resin body member 11 is larger than the static friction coefficient between the support portion P4 and the first resin body member 11. This reduces stress applied to the movable portion P2 when the second connector 110 is connected to the first connector according to the third modification. Therefore, the first connector according to the third modification can further reduce stress applied to the mount portion P1.

### Other Embodiments

Any connector according to the present disclosure is not limited to the first connector 10, and the first connector according to the first through third modifications, and can be modified within a range of its purport. Any of the structures of the first connector 10, and the first connector according to the first through third modifications, may be combined as appropriate.

Each of the first connector 10, and the first connector according to the first through third modifications, does not need to include the first ground terminal 14b or 14f. The second connector 110 does not need to include the second ground terminal 114b or 114f.

Each of the first connector 10, and the first connector according to the first through third modifications, does not need to include the second signal terminals 16c. The second connector 110 does not need to include the fourth signal terminals 116c.

The first connector only has to include one or more first signal terminals 151. The first connector only has to include one or more first signal terminals 15r. The second connector only has to include one or more third signal terminals 1151. The second connector only has to include one or more third signal terminals 115r.

Each of the first connector 10, and the first connector according to the first through third modifications, only has to include at least one of the first signal terminals 151 and 15r. In an exemplary case where each of the first connectors 10, and the first connector according to the first through third modifications, does not include the first signal terminal 151, the second connector 110 does not need to include any third signal terminal 1151. In an exemplary case where each of the first connector 10, and the first connector according to the first through third modifications, does not include the first signal terminal 15r, the second connector 110 does not need to include any third signal terminal 115r.

The first signal terminals 151 and 15r do not need to be shaped bilaterally symmetrically.

Each of the first signal terminals 15r does not need to include the projection P5.

The movable portion P2 does not need to extend in the upward-downward direction.

The contact portion P3 does not need to have the curved shape to project upward.

The contact portion P3 does not need to include the curved zone A11 shaped to be curved.

The support portion P4 does not need to extend in the upward-downward direction.

In each of the first connector 10, and the first connector according to the second and third modifications, the width of the support portion P4 may be uniform in the direction perpendicular to the upward-downward direction.

The direction perpendicular to the upward-downward direction does not need to correspond to the forward-backward direction. The direction perpendicular to the upward-downward direction may correspond to the rightward-leftward direction or the like.

The projection P5 does not need to extend in the rightward-leftward direction.

At least part of the coupler 11c does not need to be positioned just above the mount portion P1.

The first signal terminals 151 and 15r may be supported by the first resin body member 11 also in the portions other than the support portion P4.

The coupler 11c may be in contact with the mount portion P1.

At least part of the first resin body member 11 may be positioned just above or just below the movable portion P2.

At least part of the first resin body member 11 may be positioned just above or just below the contact portion P3.

At least part of the first resin body member 11 may be positioned just above or just below the support portion P4.

At least part of the frame 11b does not need to be positioned just above the projection P5. That is, the first resin body member 11 does not need to be positioned on or above the projection P5.

The upper surface of the projection P5 does not need to be in contact with the frame 11b.

When the plurality of third signal terminals 115r of the second connector 110 comes into contact with the plurality of first signal terminals 15r of the first connector 10, respectively, the movable portions P2 in the plurality of first signal terminals 15r are elastically deformed in a direction not limited to the rightward direction.

When the plurality of third signal terminals 1151 of the second connector 110 comes into contact with the plurality of first signal terminals 151 of the first connector 10, respectively, the movable portions P2 in the plurality of first signal terminals 151 are elastically deformed in a direction not limited to the leftward direction.

The support portion P4 is displaced relative to the first resin body member 11 in a direction not limited to the downward direction while being supported by the first resin body member 11. For example, the support portion P4 may be displaced relative to the first resin body member 11 in the upward direction while being supported by the first resin body member 11. In this case, the obstructor P11 may be positioned higher in level than the support portion P4 in the first connector according to the first modification. The obstructor P11 may thus limit the displaceable range in the upward direction of the support portion P4. The present disclosure provides the following configurations.
(1) A connector including a first resin body member; and one or more first external connection terminals. The one or more first external connection terminals each include a mount portion, a movable portion, a contact portion, and a support portion. The mount portion is electrically connected to an outer electrode of a member when the connector is mounted on the member. The movable portion is connected to the mount portion. The contact portion is connected to the movable portion. The contact portion comes into contact with a second external connection terminal of a second connector when the second connector is connected to the connector. Also, when the movable portion is elastically deformed due to contact between the second external connection terminal and the first external connection terminal, the support portion is supported by the first resin body member and is displaced relative to the first resin body member.
(2) The connector according to (1), in which the mount portion extends in a rightward-leftward direction, and the movable portion is positioned higher in level than the mount portion and extends in an upward-downward direction. Also, the contact portion is positioned higher in level than the movable portion and has an inner peripheral surface directed downward, and the support portion is positioned on a right side of the movable portion and extends in the upward-downward direction.
(3) The connector according to (1) or (2), in which the movable portion and the support portion are in contact with each other when the second connector is not connected to the connector.
(4) The connector according to (2) or (3), in which the first external connection terminal includes a projection extending in a rightward direction from a lower end of the support portion, and the first resin body member is positioned on or above the projection.
(5) The connector according to any one of (2) to (4), in which the support portion has a lower end positioned higher in level than the mount portion.
(6) The connector according to any one of (1) to (5), in which the contact portion includes a curved zone shaped to be curved, and the contact portion is connected to the movable portion in the curved zone.
(7) The connector according to any one of (1) to (6), in which when the movable portion is elastically deformed due to contact between the second external connection terminal and the first external connection terminal, the support portion is displaced in an upward-downward direction relative to the first resin body member.
(8) The connector according to any one of (1) to (7), in which the first resin body member includes an obstructor configured to limit a displaceable range of the support portion.
(9) The connector according to any one of (1) to (8), in which the movable portion is in contact with the first resin body member, the support portion is in contact with the first resin body member, and a static friction coefficient between the movable portion and the first resin body member is larger than a static friction coefficient between the support portion and the first resin body member.
(10) A connector set including the connector according to any one of (1) to (9); and the second connector.

What is claimed is:

1. A connector comprising:
a first resin body member; and
one or more first external connection terminals, wherein
the one or more first external connection terminals each include
a mount portion,
a movable portion,
a contact portion, and
a support portion,
the mount portion is electrically connected to an outer electrode of a member when the connector is mounted on the member,
the movable portion is connected to the mount portion,
the contact portion is connected to the movable portion,
the contact portion comes into contact with a second external connection terminal of a second connector when the second connector is connected to the connector, and
when the movable portion is elastically deformed due to contact between the second external connection terminal and the first external connection terminal, the support portion is supported by the first resin body member and is displaced relative to the first resin body member.

2. The connector according to claim 1, wherein
the mount portion extends in a rightward-leftward direction,
the movable portion is higher in level than the mount portion and extends in an upward-downward direction,
the contact portion is higher in level than the movable portion and has an inner peripheral surface directed downward, and
the support portion is on a right side of the movable portion and extends in the upward-downward direction.

3. The connector according to claim 1, wherein
the movable portion and the support portion are in contact with each other when the second connector is not connected to the connector.

4. The connector according to claim 2, wherein
the first external connection terminal includes a projection extending rightward from a lower end of the support portion, and
the first resin body member is on or above the projection.

5. The connector according to claim 2, wherein
the support portion has a lower end higher in level than the mount portion.

6. The connector according to claim 1, wherein
the contact portion includes a curved zone having a curved shape, and
the contact portion is connected to the movable portion in the curved zone.

7. The connector according to claim 1, wherein
when the movable portion is elastically deformed due to contact between the second external connection terminal and the first external connection terminal, the support portion is displaced in an upward-downward direction relative to the first resin body member.

8. The connector according to claim 1, wherein
the first resin body member includes an obstructor configured to limit a displaceable range of the support portion.

9. The connector according to claim 1, wherein
the movable portion is in contact with the first resin body member,
the support portion is in contact with the first resin body member, and
a static friction coefficient between the movable portion and the first resin body member is larger than a static friction coefficient between the support portion and the first resin body member.

10. A connector set comprising:
the connector according to claim 1; and
the second connector.

11. A connector comprising:
a first resin body member; and
one or more first external connection terminals, wherein
the one or more first external connection terminals each include
a mount portion,
a movable portion,
a contact portion, and
a support portion,
at least one of the first external connection terminals includes only one contact portion configured identically to the contact portion,
the mount portion is electrically connected to an outer electrode of a member when the connector is mounted on the member,
the movable portion is connected to the mount portion,
the contact portion is connected to the movable portion,
the contact portion comes into contact with a second external connection terminal of a second connector when the second connector is connected to the connector, and
when the movable portion is elastically deformed due to contact between the second external connection terminal and the first external connection terminal, the support portion is supported by the first resin body member and is displaced relative to the first resin body member.

12. A connector comprising:
a first resin body member; and
one or more first external connection terminals, wherein
the one or more first external connection terminals each include
a mount portion,
a movable portion,
a contact portion, and
a support portion,
the mount portion is electrically connected to an outer electrode of a member when the connector is mounted on the member,
the movable portion is connected to the mount portion,
the contact portion is connected to the movable portion,
the contact portion comes into contact with a second external connection terminal of a second connector when the second connector is connected to the connector,
when the movable portion is elastically deformed due to contact between the second external connection terminal and the first external connection terminal, the support portion is supported by the first resin body member and is displaced relative to the first resin body member, and
the mount portion extends from the movable portion toward an inner side of the connector.

13. The connector according to claim 2, wherein
the movable portion and the support portion are in contact with each other when the second connector is not connected to the connector.

14. The connector according to claim 3, wherein
the first external connection terminal includes a projection extending rightward from a lower end of the support portion, and
the first resin body member is on or above the projection.

15. The connector according to claim 3, wherein
the support portion has a lower end higher in level than the mount portion.

16. The connector according to claim 2, wherein
the contact portion includes a curved zone having a curved shape, and
the contact portion is connected to the movable portion in the curved zone.

17. The connector according to claim 2, wherein
when the movable portion is elastically deformed due to contact between the second external connection terminal and the first external connection terminal, the support portion is displaced in an upward-downward direction relative to the first resin body member.

18. The connector according to claim 2, wherein
the first resin body member includes an obstructor configured to limit a displaceable range of the support portion.

19. The connector according to claim 2, wherein
the movable portion is in contact with the first resin body member,
the support portion is in contact with the first resin body member, and
a static friction coefficient between the movable portion and the first resin body member is larger than a static friction coefficient between the support portion and the first resin body member.

20. A connector set comprising:
the connector according to claim 2; and
the second connector.
